(19) United States
(12) Patent Application Publication
(10) Pub. No.: US 2025/0071226 A1
(43) Pub. Date: Feb. 27, 2025

(54) PRINTING DEVICE, CONTROL METHOD, AND MEDIUM

(71) Applicant: CANON KABUSHIKI KAISHA, Tokyo (JP)

(72) Inventor: Ritsuto Sako, Tokyo (JP)

(21) Appl. No.: 18/945,722

(22) Filed: Nov. 13, 2024

(30) Foreign Application Priority Data
Jul. 8, 2022 (JP) 2022-110589

(51) Int. Cl. H04N 1/23; H04N 1/00

(52) U.S. Cl. CPC H04N 1/2392; H04N 1/00244; H04N 1/2346

(57) ABSTRACT

A printing device executes printing on the basis of print data obtained from a server that receives a notification of a state of the printing device and returns a response indicating an upper limit is exceeded when the notification of the state of the printing device is made at a frequency exceeding the upper limit. The printing device sends to the server the notification of the state of the printing device in accordance with progress of the printing; receives from the server a response to the notification of the state sent; and determines when a print job is completed and the printing device has entered an idle state, whether a print job to be processed consecutively is present, and if present, controlling the sending to not send the notification of the state of the printing device.

### CROSS-REFERENCE TO RELATED APPLICATIONS

This application is a Continuation of International Patent Application No. PCT/JP2023/019663, filed May 26, 2023, which claims the benefit of Japanese Patent Application No. 2022-110589, filed Jul. 8, 2022, both of which are hereby incorporated by reference herein in their entirety.

### BACKGROUND OF THE INVENTION

### Field of the Invention

The present invention relates to a printing device, a control method, and a medium storing a program in a cloud print service.

### Background Art

In past printing services, printing has been realized by a user sending a print job directly from a client terminal such as a PC to a printing device. However, cloud print services which use cloud services provided on the Internet are being proposed in recent years. In a cloud print service, a client terminal sends a print job to the cloud print service, and a printing device registered with the cloud print service obtains the print job from the cloud print service and executes the print job.

At this time, when the state of the printing device changes, the printing device sends a device state notification notifying the cloud print service of the post-change state. The device state notification is a request which is sent to the cloud print service, and is also referred to as a “device state notification request”. The state of the printing device may be “idle”, “processing”, or the like, for example. When the printing device starts printing, the state of the printing device changes from the idle state to the processing state. The printing device sends the change in this state to the cloud print service using the device state notification. When the printing device completes the printing, the state of the printing device changes from the processing state to the idle state. The printing device sends the change in this state to the cloud print service using the device state notification in this case, too.

In a cloud print service, the number of printing devices registered increases as the service expands. This results in an increased processing load in the cloud print service due to the requests from the printing devices. In particular, a device state notification from a printing device occurs multiple times while processing a single print job, and there is thus a risk that the processing load will increase due to the device state notifications. Accordingly, to lighten the processing load of device state notifications from printing devices, the cloud print service limits the number of device state notifications processed per unit of time. When the number of requests such as device state notifications exceeds an upper limit, the cloud print service returns an error to the requesting printing device indicating that too many requests have been made (the upper limit has been exceeded).

Meanwhile, PTL 1, for example, has been proposed as a technique for reducing the communication load for state confirmation notifications between a cloud printing server and a plurality of printing devices. PTL 1 discloses a configuration in which a master printer performs state confirmation communication with the cloud printing server, whereas slave printers do not perform state confirmation communication with the cloud printing server.

### CITATION LIST

### Patent Literature

PTL 1: Japanese Patent Laid-Open No. 2013-129146

However, although the number of device state notifications can be reduced by the method of PTL 1, the cloud print service cannot ascertain the state of all the printing devices registered with the cloud print service. In this method, it is also necessary to perform a procedure among the printing devices to determine the master and the slaves, which increases the processing loads of the printing devices as a result.

Furthermore, with a method that returns an error in response to a device state notification when the number of requests received in a unit of time exceeds an upper limit, the error is displayed in the user interface (UI) of a printing device. This is particularly likely to occur in situations such as when a plurality of print jobs having low printing volumes are processed in succession. When the state of a printing device changes, a device state notification is sent to the cloud print service in response to the change. For example, when a print job is started, the state transitions from the idle state to the processing state, and thus a device state notification indicating the processing state is sent to the cloud print service. When a print job is completed, the state transitions from the processing state to the idle state, and thus a device state notification indicating the idle state is sent to the cloud print service. In this manner, when the processing of a print job progresses normally, the printing device sends at least two device state notifications to a cloud print service for a single print job.

Therefore, particularly when executing a plurality of print jobs having low print volumes in succession, the device state changes more frequently, and device state notifications are therefore sent more frequently as well. As a result, it is more likely that the load on the cloud print service will exceed a predetermined upper limit, and a number of responses exceeding the upper limit will be returned.

The device state notification is not a request sent by users intentionally, and thus even if a typical user sees an error display indicating that the server load has exceeded the upper limit, the user will be unable to understand the cause and solution, which can cause confusion at sites where the cloud print service is used.

### SUMMARY OF THE INVENTION

Having been achieved in light of the past examples described above, the present invention realizes smooth usage of a cloud print service by suppressing error reports to which a user need not respond, while ensuring the state of a printing device can be understood in the cloud print service.

In order to achieve the above object, the present invention is configured as follows. According to one aspect of the present invention, a printing device is provided that executes printing on the basis of print data obtained from a server that receives a notification of a state of the printing device and returns a response indicating a predetermined upper limit is exceeded when the notification of the state of the printing device is made at a frequency exceeding the upper limit, the printing device comprising:
at least one memory storing instructions; and
at least one processor that is in communication with the at least one memory and that, when executing the instructions, cooperates with the at least one memory to execute processing, the processing including
sending, to the server, the notification of the state of the printing device in accordance with progress of the printing;
receiving, from the server, a response to the notification of the state sent; and
determining, when a print job is completed and the printing device has entered an idle state, whether a print job to be processed consecutively is present, and if the print job to be processed consecutively is present, controlling the sending to not send the notification of the state of the printing device.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a processing sequence chart for cloud printing.

FIG. 2 is a schematic diagram of a cloud print system.

FIG. 3 is a hardware configuration diagram of a printing device.

FIG. 4 is a software configuration diagram of the printing device.

FIG. 5 is an explanatory diagram of a console of the printing device.

FIG. 6 is a sequence chart of when the printing device of a first embodiment obtains consecutive jobs.

FIG. 7 is a flowchart of when the printing device of the first embodiment obtains consecutive jobs.

FIG. 8 is a diagram illustrating a job management table in the printing device of the first embodiment.

FIG. 9 is a sequence chart of when the printing device of the first embodiment sends a device state notification while processing consecutive jobs.

FIG. 10 is a flowchart of when the printing device of the first embodiment sends a device state notification.

FIG. 11 is a diagram illustrating a type of a printer state of the printing device of the first embodiment.

FIG. 12 is a diagram illustrating a display panel according to the printer state of the printing device of the first embodiment.

FIG. 13 is a flowchart illustrating when a printing device of a second embodiment sends a device state notification.

FIG. 14 is a flowchart illustrating when a printing device of a third embodiment sends a device state notification.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Hardware

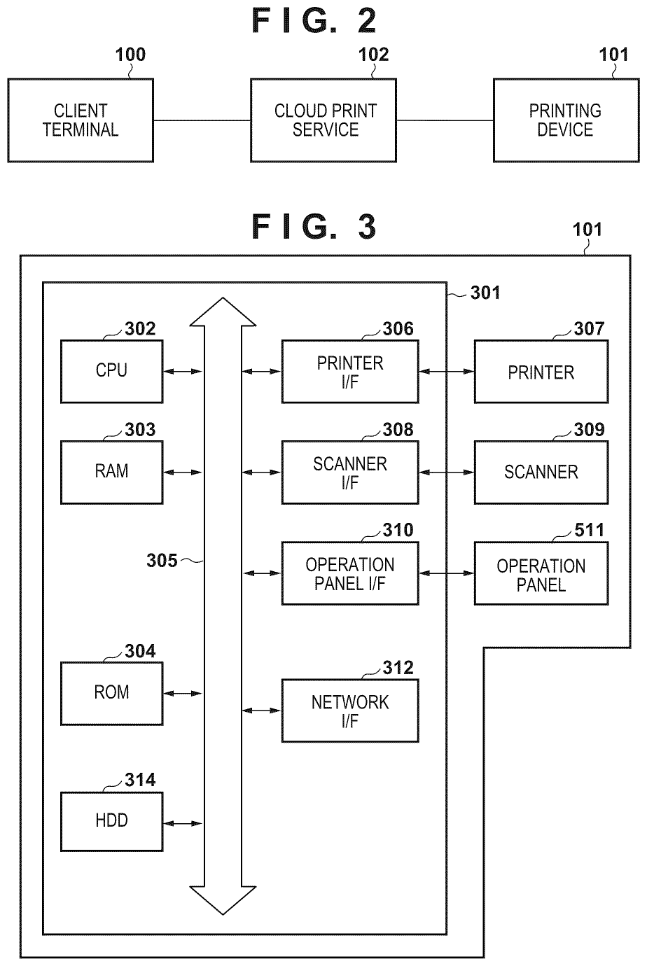

FIG. 2 is a diagram illustrating the configuration of a cloud print system serving as an embodiment of the present invention. A cloud print service 102 is a service provided by one or more servers connected to a client terminal 100 and a printing device 101 over the Internet or the like, for example. Here, “cloud print service 102” refers to a server that is an information processing device providing the cloud print service.

The present embodiment assumes that the Internet Printing Protocol (IPP) is used for communication between the printing device 101 and the cloud print service 102. Operations and attributes according to IPP will be used in the following descriptions.

FIG. 3 is a block diagram illustrating the hardware configuration of the printing device 101 according to the present invention. A control unit 301 that includes a CPU 302 controls the operations of the printing device 101 as a whole. The CPU 302 performs various types of control, such as communication control and the like, by reading out and executing control programs stored in a ROM 304.

A RAM 303 is used as the main memory of the CPU 302, a temporary storage region such as a work area, or the like. An HDD 314 stores data, various types of programs, or various types of information tables.

A printer interface (I/F) 306 functions as an interface for outputting image signals to a printer 307 (a printer engine). A scanner I/F 308 functions as an interface for inputting read image signals from a scanner 309 (a scanner engine). The CPU 302 processes an image signal input from the scanner I/F 308, and outputs the resulting signal as a recording image signal to the printer I/F 306. The printer 307 forms an image on a medium such as a sheet or the like in accordance with the recording image signal.

An operation panel I/F 310 connects an operation panel 511 to the control unit 301. The operation panel 511 includes a liquid crystal display unit having touch panel functionality, a keyboard, and the like. A network I/F 312 transmits information to external terminals such as the client terminal 100 and the cloud print service 102, receives various types of information from external devices, and the like. The various blocks in the control unit 301 are connected to each other by a system bus 305.

Note that the printing device 101 may also be called a printer, an image forming device, or a recording device.

The client terminal 100 and the cloud print service 102 have the configuration illustrated in FIG. 3, with the printer I/F 306 and the printer 307, and the scanner I/F 308 and the scanner 309, removed. However, the performance of the CPU 302 and the capacities of the RAM 303 and the HDD 314 need not be the same, and the client terminal 100 and the cloud print service 102 may have better performance. The same applies to the operation panel 511, and the client terminal 100 and the cloud print service 102 may be more general-purpose, and have higher display capabilities.

### Software

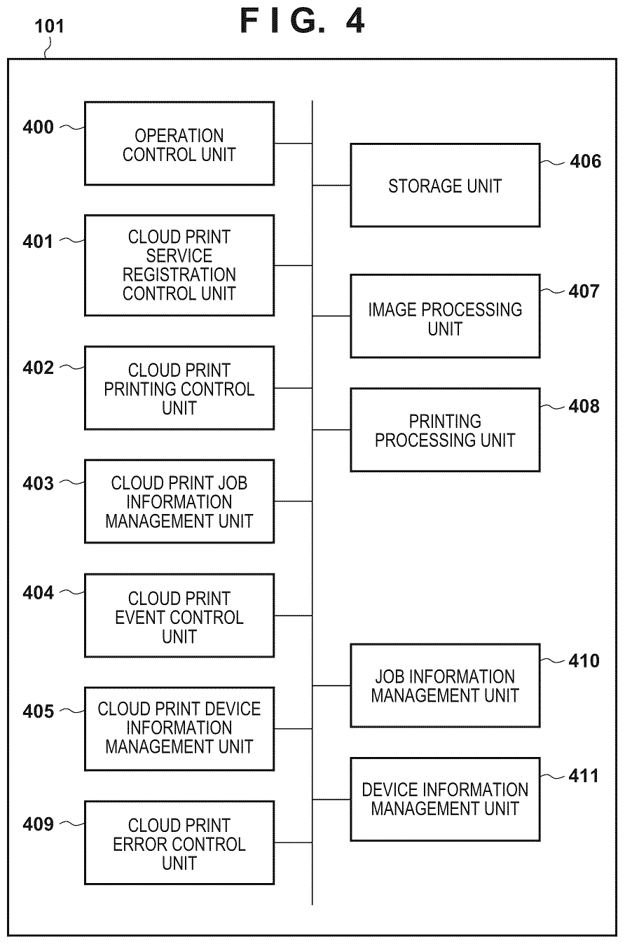

FIG. 4 is a diagram illustrating the software configuration of the printing device 101. The function units illustrated in FIG. 4 are realized by the CPU 302 of the printing device 101 executing control programs.

An operation control unit 400 controls the operation panel 511. The operation control unit 400 displays an operation menu in the operation panel 511 and receives the input of instructions from a user, notifies other function units of the details of the instructions received, and displays results of the instructions in the operation panel 511. A cloud print service registration control unit 401 analyzes a cloud print service registration request received from the client terminal 100, and sends the cloud print service registration request to the cloud print service 102. Cloud print service registration processing is controlled as a result.

A cloud print printing control unit 402 transfers print data received from the cloud print service 102 to an image processing unit 407. The image processing unit 407 performs processing for rendering print jobs into image data for printing.

A printing processing unit 408 performs processing for printing the image data rendered by the image processing unit 407. A cloud print job information management unit 403 manages cloud print job information of the printing device 101, and notifies the cloud print service 102 thereof.

A cloud print event control unit 404 controls processing for sending events and receiving events between the printing device 101 and the cloud print service 102. A cloud print device information management unit 405 notifies the cloud print service 102 of device information of the printing device 101. A cloud print error control unit 409 manages an error occurrence state of the printing device 101.

A storage unit 406 stores designated data in the ROM 304, the HDD 314, or the like, or reads out stored data, in response to instructions from other function units. ID information and QR code (registered trademark) image information identifying the device are examples of the data managed by the storage unit 406.

A job information management unit 410 manages job information of the printing device 101. This unit manages job data spooled in the HDD 314 or the like, a print job queue, and the like.

A device information management unit 411 manages the device information of the printing device 101. Specifically, this unit manages an operating state, the error occurrence state, and the like of the device.

### Console

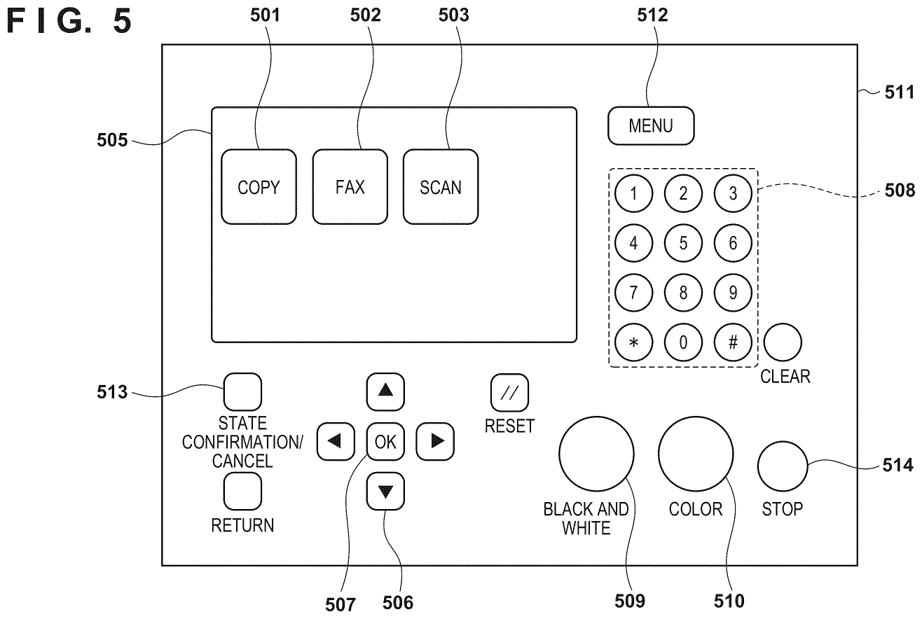

FIG. 5 is a diagram illustrating the operation panel 511 of the printing device 101. A display panel 505 is a device that includes a display panel and a touch panel using an LCD or the like, and provides a UI. A copy button 501 is a button pressed when copying using the printing device 101, and when that button is pressed, a copy operation screen is displayed in the display panel 505. A facsimile button 502 is a button pressed when faxing using the printing device 101, and when that button is pressed, a facsimile operation screen is displayed in the display panel 505. A scan button 503 is a button pressed when scanning using the printing device 101, and when that button is pressed, a scan operation screen is displayed in the display panel 505. A QR code (registered trademark) image or the like is also displayed in the display panel 505.

A numerical keypad 508 is used to input numbers and the like. An OK key 507 is used, for example, when receiving content displayed in the display panel 505. A directional key 506 is used, for example, when selecting a menu or the like displayed in the display panel 505. A black-and-white copy button 509 and a color copy button 510 are used when executing black-and-white copying and color copying, respectively. A stop button 514 is used when stopping processing. A menu button 512 is used when displaying a menu screen for making settings in the printing device 101. A status confirmation/cancel button 513 is used when confirming the status of the printing device 101, such as a list of print jobs received by the printing device 101.

In the first embodiment, the printing device confirms whether a subsequent job to be processed is present when one job ends. If the subsequent job is present, no device state notification is made. This reduces the number of device state notification requests and ensures that errors are not returned from the cloud print service 102.

### Cloud Printing Processing Sequence

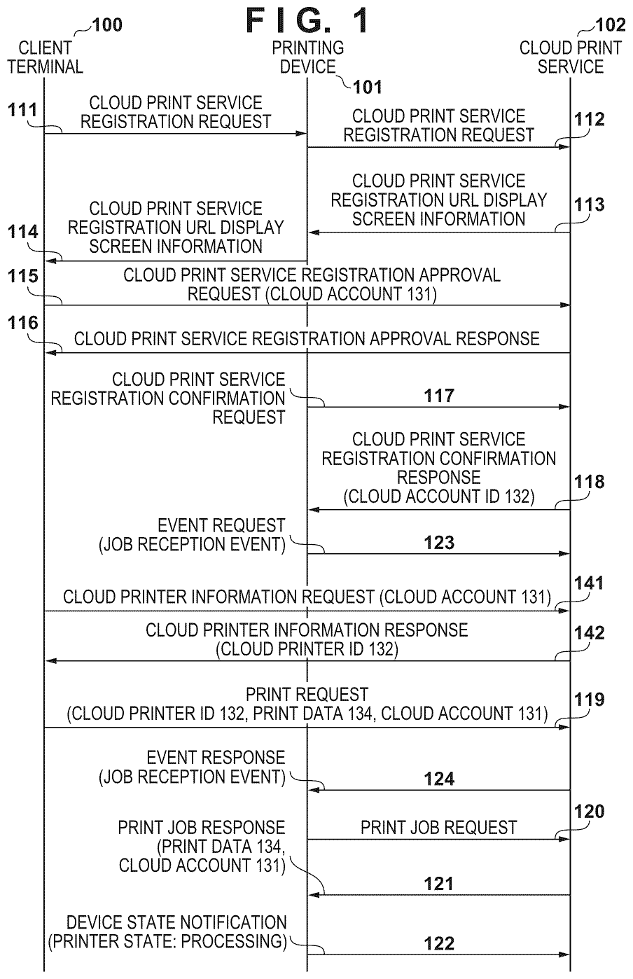

A processing sequence for cloud printing will be described here with reference to FIG. 1. The printing device 101 supports a cloud printing function and a web UI (also called “remote UI”) function for operating the printing device 101. The client terminal 100 supports a cloud printing client function and a web UI client for operating the web UI. The web UI function is a function in which, for example, the printing device 101 functions as an HTTP server and provides a user interface (UI) of the printing device 101 to an HTTP client (a web UI client, e.g., a web browser) of the client terminal 100. “Cloud print service 102” refers to a cloud print service on the Internet.

The user first sends a cloud print service registration request 111 to the printing device 101 through the web UI, using the web UI client of the client terminal 100. Upon receiving the request 111, the printing device 101 sends a cloud print service registration request 112 to the cloud print service 102. Upon receiving the request 112, the cloud print service 102 sends a cloud print service registration request response 113, including a registration URL 130 for cloud print registration, to the printing device 101. Upon receiving the response 113, the printing device 101 sends registration URL display screen information 114, including the cloud print service registration URL, to the client terminal 100 via the web UI.

Upon receiving the screen information 114, the client terminal 100 displays the registration URL in the web UI client. The user operates the web UI client of the client terminal 100 and accesses the displayed registration URL. Through this, the client terminal 100 sends a cloud print service registration approval request 115, including a cloud account 131, to the cloud print service 102.

Upon receiving the registration approval request 115, the cloud print service 102 sends a cloud print service registration approval response 116 to the client terminal 100. The cloud account 131 indicates a user authorized to use the cloud print service 102, and the user has registered a user account with the cloud print service 102 in advance.

The printing device 101 sends a cloud print service registration confirmation request 117 to the cloud print service 102. Upon receiving the registration confirmation request 117, the cloud print service 102 sends a cloud print service registration confirmation response 118, including a cloud printer ID 132, to the printing device 101. At this stage, the printing device 101 enters a state of being registered with the cloud print service 102 and being capable of using the cloud print service.

After completing the registration in the sequence described thus far, the printing device 101 then sends an event request 123 to the cloud print service 102. A job reception event is designated as the type of the requested event in the event request 123.

The client terminal 100 sends a cloud printer information request 141 to the cloud print service 102. The cloud printer information request 141 includes the cloud account 131. Upon receiving the cloud printer information request 141, the cloud print service 102 obtains printer information indicating that the cloud account 131 included in the request can be used. A cloud printer information response 142, holding the cloud printer ID 132 indicating the printer information, is then sent to the client terminal 100.

The client terminal 100 sends, to the cloud print service 102, a print request 119 including, for example, the cloud printer ID 132 selected by the user from among printing devices that can be used, print data 134 to be printed, and the cloud account 131. Here, the cloud printer ID 132 is assumed to include the ID of the printing device 101. Upon receiving the print request 119, the cloud print service 102 saves information received with the print request 119, e.g., the cloud printer ID 132, the print data 134, and the cloud account 131. The cloud print service 102 also sends an event response 124 to the printing device 101 that sent the event request. The event response 124 is a message which is sent as a response to the event request 123, and a job reception event is designated as the type of the event.

Upon receiving the event response 124, the printing device 101 sends a print job request 120 to the cloud print service 102. The cloud print service 102 sends a print job response 121, including the print data 134 and the cloud account 131, to the printing device 101. The printing device 101 prints the received print data.

When the state thereof changes, the printing device 101 sends a device state notification 122 to the cloud print service 102. In this sequence, when the printing device starts printing, the state of the printing device changes from the idle state to the processing state. Accordingly, “processing” is set for the printer state in the device state notification 122.

Upon receiving the device state notification 122, if the device state notification 122 was successfully received, the cloud print service 102 sends, to the printing device 101, a response (e.g., a code 200) indicating that sending was successful. The device state in the notification is also stored in association with the printing device 101 from which the notification was sent. On the other hand, if, for example, the number of requests received within a predetermined length of time exceeds an upper limit, a code 429 indicating “too many requests” (an upper limit exceeded response) is sent to the printing device 101 as a response to that effect. In addition, if the device state notification was successfully received but cannot be processed, a response making a notification of that state is sent to the printing device 101. In these cases, the device state (printer state) in the notification is not saved by the cloud print service 102.

Having received a response other than that sending was successful, e.g., the upper limit exceeded response, the printing device 101 displays a message to that effect in the operation panel 511, and particularly in a state display field provided therein. The stated upper limit may be set, for example, for each tenant, for each printing device, or for the total of all tenants.

In FIG. 1, the printing device 101 sends the print job request 120 in response to the event response 124 and obtains the print job. However, the printing device 101 may instead request a print job list, and obtain a list of jobs that can be printed by the printing device 101. In such a case, the job list obtained by the printing device 101 is displayed in the operation panel 511 or the remote UI. The user then sends a print job request 120 for the print job selected from the job list. The processing following thereafter is as illustrated in FIG. 1. Furthermore, according to the IPP, the print job is obtained over several stages, such as obtaining print settings and obtaining the print data, rather than through a single request.

Doing so makes it possible to know all of a plurality of executable print jobs when such a plurality of executable print jobs are held in the cloud print service 102, and select the job to be printed. In addition, when a plurality of executable print jobs are held in the cloud print service 102 and one thereof is obtained and executed by the printing device 101, another print job may, during that time, be obtained and held in the printing device 101. This operation may be performed to the extent permitted by the capacity of the storage unit 406.

Processing when Executing Sequential Jobs

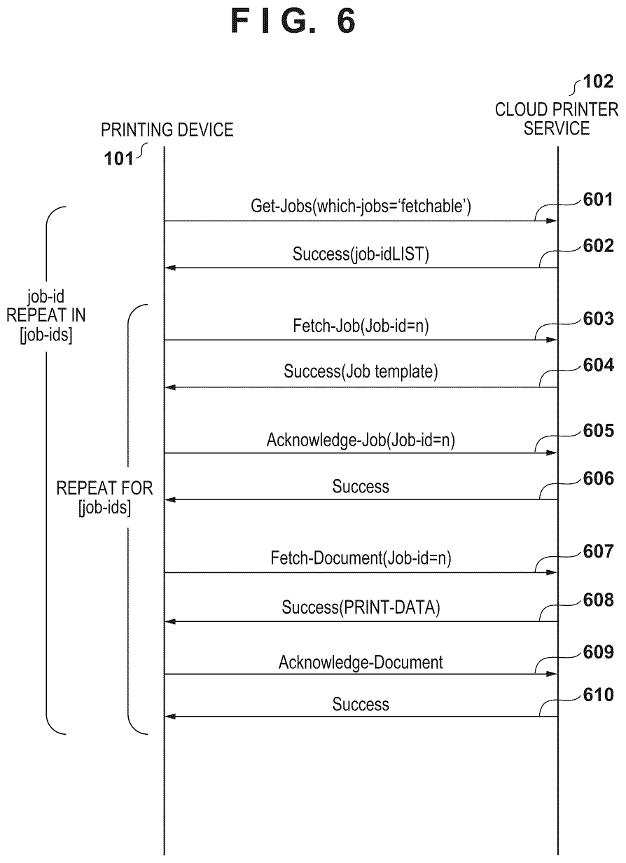

FIG. 6 is a sequence chart of when the printing device 101 of the first embodiment obtains consecutive jobs. This sequence follows the event response 124 in FIG. 1, and starts from the obtainment of a job list. Operations and attributes according to IPP will be used in the following descriptions.

The printing device 101 sends a Get-Jobs request 601 to the cloud print service 102. At this time, ‘fetchable’ is set in the which-jobs attribute. This makes it possible to inquire as to whether there is a print job that can be received. This corresponds to the request for the print job list indicated in FIG. 1. If there is a print job that can be received, the cloud print service 102 sends, to the printing device 101, a Success response 602 in which a job-id list is set. job-id information (a job ID) of one or more print jobs that can be received is set in the job-id list.

The printing device 101 requests print settings for the job by sending a Fetch-Job request 603 to the cloud print service 102. At this time, the job-id obtained in the Success response 602 is set for the job-id attribute. The cloud print service 102 sends a Success response 604 to the printing device 101. At this time, the print settings of the job are set in the job-template attribute of the response.

Upon successfully receiving the print settings for the job through the Success response 604, the printing device 101 sends an Acknowledge-Job request 605 to the cloud print service 102. At this time, the job-id set in the Fetch-Job request 603 is set for the job-id attribute. Upon receiving the Acknowledge-Job request 605, the cloud print service 102 sends a Success response 606 to the printing device 101.

Upon receiving the Success response 606, the printing device 101 sends a Fetch-Document request 607 to the cloud print service 102. The print data is requested as a result. At this time, the job-id set in the Fetch-Job request 603 is set for the job-id attribute.

The cloud print service 102 sends a Success response 608 to the printing device 101. At this time, the print data is sent at the same time.

Upon successfully receiving the print data in the response 608, the printing device 101 sends an Acknowledge-Document request 609 to the cloud print service 102. Upon receiving the Acknowledge-Document request 609, the cloud print service 102 sends a Success response 610 to the printing device 101. The printing device 101 prints the print data received in the response 610 using the print settings of the job obtained in the response 604.

The response 610 from the Fetch-Job request 603 is processing pertaining to the specific job-id. The printing device 101 repeats this processing for all of the job-ids included in the job-id list obtained in the response 602.

In addition, a print job that can be received while executing the response 610 from the Fetch-Job request 603 may have been entered in the cloud print service 102. Accordingly, when the processing of the response 610 is complete, the sequence returns to the Get-Job request 601 and repeats. The processing is continued until the job-id list is no longer returned in the response 602. If the job-id list is not returned, the printing device 101 may, for example, send the event request 123 to the cloud print service 102, wait for the event response 124 to be received, and repeat the sequence in FIG. 6 again.

### Processing of Sequential Jobs by Printing Device 101

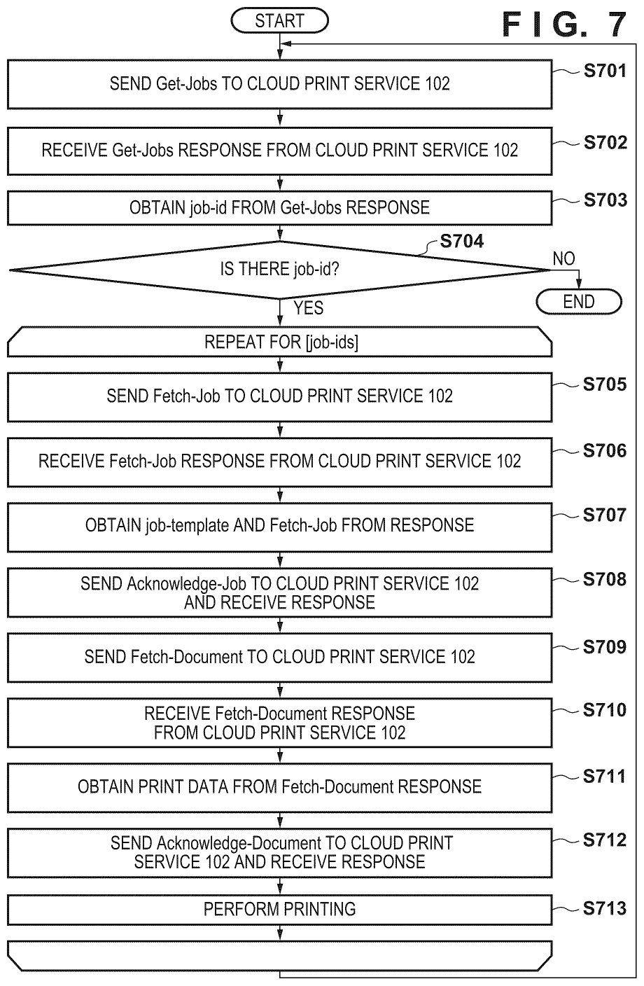

FIG. 7 is a flowchart of when the printing device 101 of the first embodiment consecutively obtains print jobs. This flowchart is executed when the printing device 101 has received the event response 124 (the job reception event). This sequence will be described as being executed by the cloud print printing control unit 402 of the printing device 101 and the like. However, the software configuration illustrated in FIG. 4 is realized by the CPU 302 executing programs, and can therefore also be said to be executed by the CPU 302.

In S701, the cloud print printing control unit 402 sends a Get-Jobs request to the cloud print service 102. At this time, “fetchable” is set in the which-jobs attribute. In S702, the cloud print printing control unit 402 receives a response in which a job-id list that can be received is set.

In S703, if a job-id is included in the received response, the cloud print printing control unit 402 extracts the job-id and adds the job-id to an IPP job management table. At that time, the job-state (job state) is set to pending (not yet processed).

In S704, whether the job-id was successfully obtained from the received response is determined; if not, i.e., if no job-id is included in the response, the sequence ends. If so, however, the sequence moves to S705.

The processing of S705 to S712 is repeated for each job-id obtained from the response. If a plurality of Job-ids are included, the processing of S705 to S712 is performed for those Job-ids.

In S705, the cloud print printing control unit 402 sends a Fetch-Job request to the cloud print service 102. At this time, one of the job-ids included in the Get-Jobs response is set for the job-id attribute. This job-id may be the first job ID in a predetermined order among those which are registered in the IPP job management table and which have a job state is “pending (not yet processed)”. Note that the print job with this job ID may also be called a “target print job” due to being a “target” print job to be processed. The job state of the target print job registered in the IPP job management table may be set to “processing” at this time. However, the job state of the target print job may be changed to “processing” in S706 thereafter, or in S712 immediately before the printing processing is actually started.

In S706, the cloud print printing control unit 402 receives the Fetch-Job response from the cloud print service 102. The job-template attribute indicating the print settings of the target print job specified in the job-id attribute is set in the Fetch-Job response. In S707, the cloud print printing control unit 402 obtains job-template information, i.e., the print settings of the target print job, from the response.

In S708, the cloud print printing control unit 402 sends an Acknowledge-Job request to the cloud print service 102, and receives a response thereto.

In S709, the cloud print printing control unit 402 sends a Fetch-Document request to the cloud print service 102. At this time, the job-id of the target print job is set for the job-id attribute.

In S710, the cloud print printing control unit 402 receives a Fetch-Document response from the cloud print service 102. The print data of the target print job specified in the job-id attribute is included in the Fetch-Document response. In S711, the cloud print printing control unit 402 obtains the print data from the response.

In S712, the cloud print printing control unit 402 sends an Acknowledge-Document request to the cloud print service 102, and receives a response thereto.

In S713, the cloud print printing control unit 402 prints the print data received in the Fetch-Document response using the print settings indicated by the job-template attribute received in the Fetch-Job response. Once the execution is completed, the job state of the target print job in the IPP job management table may be set to “completed”.

If a job ID having a job state of “pending (not yet processed)” remains in the job IDs registered in the IPP job management table, the sequence is repeated from S705, taking the first job ID in the predetermined order as the job ID of the next target print job, for example.

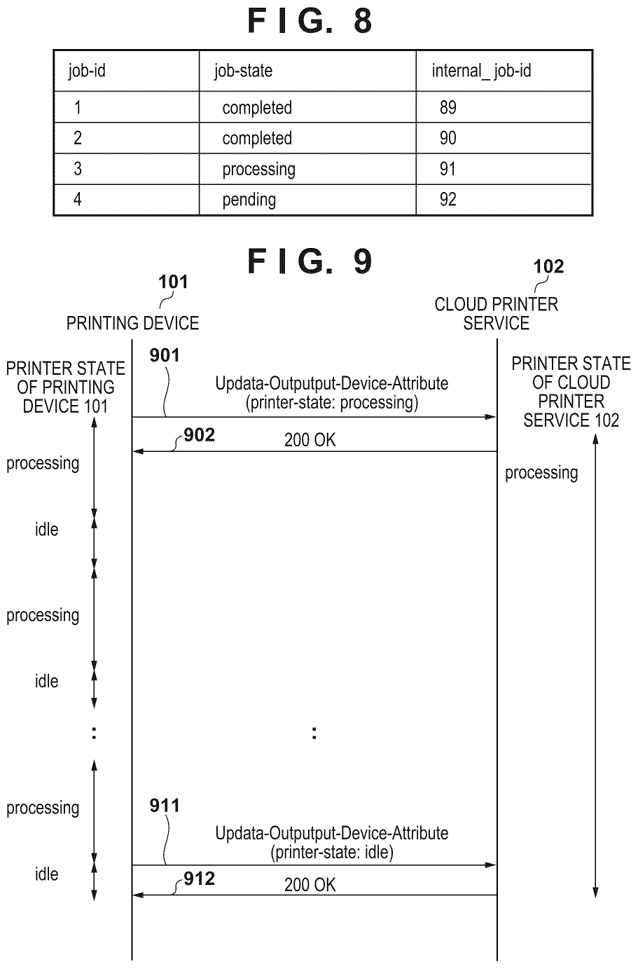

FIG. 8 is a diagram illustrating the IPP job management table in the printing device of the first embodiment. “job-id” is the job-id in the notification by the cloud print service 102 in the Get-Jobs response 602. “job-state” indicates the job state. Here, the job states include “completed”, which indicates that the processing is completed (the printing is completed), “processing”, which indicates that processing (printing) is in progress, “pending”, which indicates that the processing is pending (printing is pending), and the like.

“internal_job-id” is a job-id managed within the printing device 101. A job is entered to the printing device 101 not only through IPP, but through various other means as well. This is an ID for uniquely identifying such jobs.

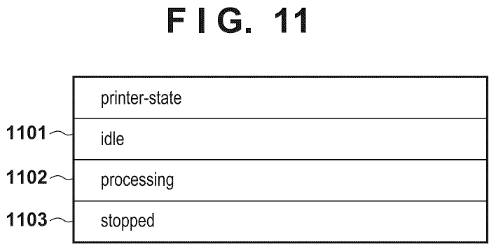

FIG. 11 is a diagram illustrating types of printer states (also referred to as “device states”) of the printing device of the first embodiment. “printer-state”, of which the cloud print service 102 is notified by the cloud print device information management unit 405 of the printing device 101 using Update-Output-Device-Attributes, includes three printer states.

The first is an idle state 1101. This is a state in which the printing device is not processing a print job, and is a state in which when a new job is entered, the printing processing can be started without waiting.

The second is a processing (or printing) state 1102. This is a state in which the printing device is processing a print job, and is a state in which a wait will occur when a new job is entered.

The third is a stopped state 1103. This is a state in which the printing device cannot process a print job, and is a state in which a user operation is required to change the state.

The printing device 101 according to the present embodiment is in one of these three states. Although the stopped state will not be specifically described in the present embodiment, it is of course possible for the device to enter the stopped state. A plurality of stopped states may be provided according to the cause of the stopped state, and other states may be provided.

### Device State Notification Processing

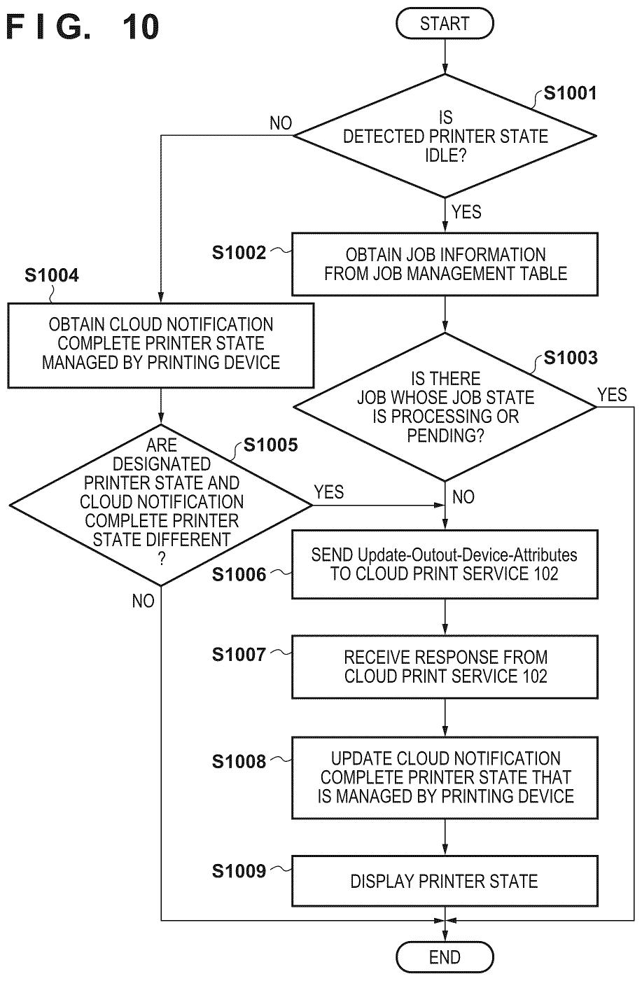

FIG. 9 is a sequence chart of when the printing device 101 of the first embodiment sends a device state notification while processing consecutive jobs. Upon receiving the print job response 121 from the cloud print service 102, the printing device 101 starts printing processing for the received print data 134. Note that the print job response 121 corresponds to the Fetch-job response indicated in FIGS. 6 and 7, and the printing device 101 performs the printing processing after the Fetch-job response indicated in FIG. 6, and after S706 in FIG. 7. However, this processing may be performed after the Fetch-job request, or after printing is executed in S713.

When the printing device 101 starts the printing processing, the device state of the printing device 101 becomes the processing state. The device state may be set, for example, by the device information management unit 411 monitoring the state of the printer 307, the state of signals in the printer I/F 306, or the like, and setting the state to “processing” if printing operations are underway, and to “idle” if not. If an error has occurred, toner or paper has run out, or the like, a corresponding state (e.g., a stopped state, an error state, or the like) may be set. For example, if the state of at least one of the print jobs registered in the IPP job management table is “processing”, the device state may be assumed to be the processing state.

When the device state of the printing device 101 changes to the processing state, the printing device 101 sets “processing” in the printer-state attribute using Update-Output-Device-Attributes, and sends the state (901). Update-Output-Device-Attributes is an IPP operation. In other words, a device state notification is sent. Here, the printer-state attribute indicates the device state (the printer state, when the device is a printer). Upon receiving the request 901, the cloud print service 102 updates the state of the printing device 101 managed in the cloud print service 102 to the received device state, which here is the processing state. A status code 200 (OK: sending successful) is also returned to the printing device 101 (902).

When the printing device 101 completes the printing processing, the device state of the printing device 101 becomes the idle state. However, this is also conditional, for example, on an event that causes the printing device 101 to stop its functions not having occurred, e.g., an event requiring user intervention. Events requiring user intervention include, for example, malfunctions, running out of paper, running out of toner, or the like.

The printing device 101 confirms the next job to be processed by the printing device 101. This confirmation may be made by referring to the job management table, for example. Among the print jobs registered in the job management table, a print job having a job state of “pending” becomes the next target print job. If there are a plurality of print jobs having a job state of “pending”, for example, the first print job in a predetermined order becomes the next target print job. In the present embodiment, the printing device is in a state where consecutive jobs are being received, and a next job is therefore present, at least after the first job.

In this case, in the present embodiment, the printing device 101 does not send the Update-Output-Device-Attributes, which is an IPP operation, despite the printer state of the printing device 101 having changed to the idle state. In other words, when there is a next print job to be executed after the printing device 101 has completed one print job, if the device state for which the notification is to be made is “idle”, the cloud print service 102 is not notified thereof. In other words, when the conditions that one print job has been completed, there is a next print job to be executed, and the device state for which the notification is to be made is “idle” have all been met, the printing device 101 does not send the device state notification. Accordingly, the printer state on the cloud print service 102 remains in the processing state.

Thereafter, the next job is started, and the printer state of the printing device 101 becomes the processing state. However, the printer state of which the cloud print service 102 has been notified by the printing device 101 is “processing”, which is the same as the post-update device state. Update-Output-Device-Attributes is therefore not sent at this time.

As long as there are consecutive jobs, the printing device 101 processes the print jobs through the sequence described above, but does not send Update-Output-Device-Attributes, which is a device state notification, during that time.

When the printing device 101 completes the printing processing for the last job and the printer state of the printing device 101 changes to the idle state, the printing device 101 confirms whether there is a next job. At this time, there is no next job, and the printing device 101 therefore sets the printer-state attribute to “idle” using Update-Output-Device-Attributes, which is an IPP operation, and sends the state (911). Upon receiving the request 911, the cloud print service 102 updates the state of the printing device 101 managed in the cloud print service 102 to “idle” and responds with “200 OK” to the printing device 101 (912).

As described above, the device state notification is not sent, and the processing state is maintained, while a next print job to be executed is standing by at the point in time when a print job is completed.

### Device State Notification Sending Processing

FIG. 10 is a flowchart of when the printing device of the first embodiment sends the device state notification. This flowchart is executed when the cloud print device information management unit 405 detects a change in the printer state. Accordingly, this processing may be executed asynchronously from the sequence in FIG. 6. Although the processing illustrated in FIG. 10 is also executed by the software illustrated in FIG. 4, and by the cloud print device information management unit 405 in particular, the cloud print device information management unit 405 is realized by the CPU 302, and thus can also be said to be executed by the CPU 302.

The cloud print device information management unit 405 determines whether the detected printer-state attribute, i.e., the printer state, is “idle”. The process moves to S1004 if the state is not “idle”, and to S1002 if the state is “idle”.

In S1002, the cloud print device information management unit 405 obtains the job information from the IPP job management table.

In S1003, the cloud print device information management unit 405 determines whether a job in which the job-state (job state) is “processing” or “pending” is present, based on the obtained job information. If such a job is determined to be present, the printer state changes to “processing” in the change in the printer state immediately thereafter. Accordingly, the device state notification is not made using Update-Output-Device-Attributes, and the sequence ends. If no corresponding job is determined to be present in step S1003, the sequence moves to step S1006.

In S1006, the cloud print device information management unit 405 sends an Update-Output-Device-Attributes request to the cloud print service 102. This request includes a printer-state set to the detected printer state. In other words, a device state notification is sent to notify the cloud print service 102 that the printer state has become “idle”.

In S1007, the cloud print device information management unit 405 receives an Update-Output-Device-Attributes response from the cloud print service 102.

In S1008, the cloud print device information management unit 405 updates the printer-state of which the cloud was notified (a cloud notification complete printer state), managed by the printing device 101, to the printer state sent in S1006. The cloud notification complete printer-state is saved in the storage unit 406.

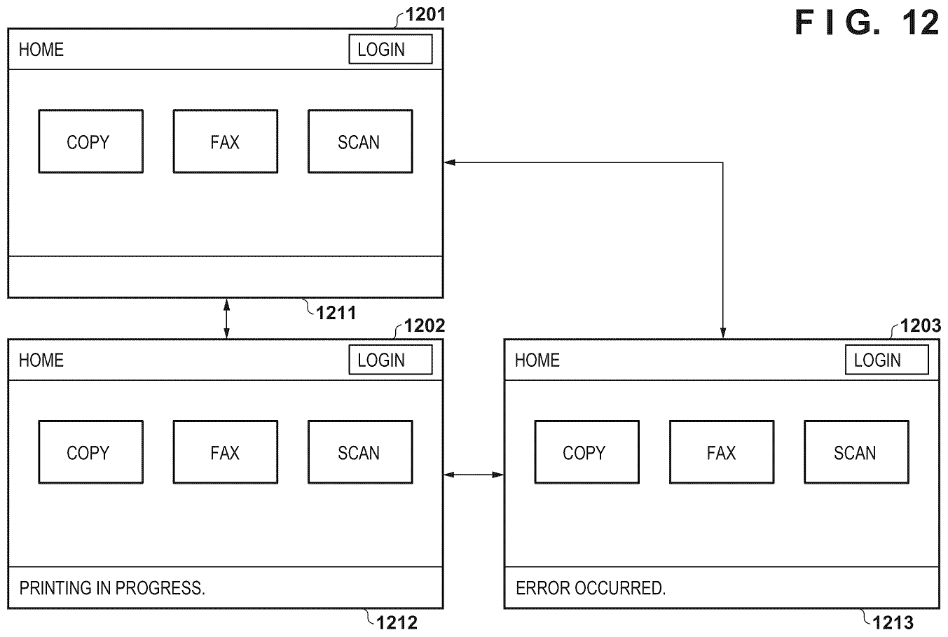

In S1009, the cloud print device information management unit 405 displays the printer state of which to the cloud print service 102 has been notified in the printer state display part of the display panel 505. If the printer state is “idle”, there is no particular display indicating the state. If the printer state is a state other than “idle”, a display indicating the state is made. An example of this display will be described later with reference to FIG. 12.

The processing performed when the printer-state detected in S1001 is not “idle” will be described next.

If the printer-state detected in step S1001 is determined not to be “idle”, the cloud print device information management unit 405 reads out the cloud notification complete printer-state from the storage unit 406 in S1004.

In S1005, the cloud print device information management unit 405 compares the detected printer-state to the cloud notification complete printer-state. If the states are the same, the sequence ends. If the states are different, the sequence moves to S1006. From S1006 on, the cloud print device information management unit 405 notifies the cloud print service 102 of the detected printer state, and updates the cloud notification complete printer-state to the printer state of the notification.

### Display Example

FIG. 12 is a diagram illustrating an example of the display of screens according to the printer state of the printing device of the first embodiment. These screens are displayed by the operation control unit 400 in the display panel 505, and are displayed in S1009 of FIG. 10. In other words, although the display is one made according to the printer state, the state of which the cloud print service 102 has been notified using the device state notification is displayed here. A state of which the cloud print service 102 has not been notified is not displayed, even if the printer state changes. Additionally, when a response other than “sending successful” (OK) is received from the cloud print service 102, the received state may be displayed in the same field as the printer state. This may, for example, involve displaying the state of the response received when the response 912 in FIG. 9 is received, or when the response 602, 604, 606, 608, or 610 is received in the sequence of FIG. 6. However, in this case, if a response indicating “sending successful” has been received, the state need not be displayed.

A screen 1201 indicates an example of a screen in which the printer-state is the idle state 1101. A status line 1211 is an area in which the printer states, errors, and the like are displayed. Nothing is displayed in the status line 1211 when the printer-state is the idle state 1101.

A screen 1202 indicates an example of the display made when the printer-state is the processing state 1102. “Printing in progress” is displayed, as indicated by a status line 1212, when the printer-state is the processing state 1102.

A screen 1203 indicates the display panel when the printer-state is the stopped state 1103. “An error has occurred”, as indicated by a status line 1213, is displayed when the printer-state is the stopped state 1103.

The configuration of the first embodiment has been described thus far. In the first embodiment, the state of the job is indicated by referring to the IPP job management table in the flowchart of FIG. 10 and the like. However, the configuration is not limited to IPP jobs, and may be such that a job management table which manages all the jobs in the printing device is referred to.

As described above, in the present embodiment, the printing device 101 does not notify the cloud print service 102 of a change in the printer state to the idle state and the processing state occurring due to the consecutive execution of a plurality of print jobs obtained from the cloud print service 102. This can make it less likely that the cloud print service 102 will enter a state where the number of requests received within a predetermined length of time exceeds a predetermined upper limit. If such a state does not occur, the cloud print service 102 does not return an upper limit exceeded response indicating that the load has exceeded the upper limit, and thus an error state caused by the reception of the upper limit exceeded response will not arise in the printing device 101. This makes it possible to ascertain the state of the registered printing devices in the cloud print service 102, while reducing the load of the cloud print service 102 and suppressing the occurrence of error states.

### Second Embodiment

A second embodiment will be described next. The configuration of the first embodiment was one in which when there is a job to be processed next in the printing device, a notification that the printer-state has become “idle” is not made using Update-Output-Device-Attributes. However, if the user is manually performing printing operations for a plurality of print jobs, even if a next job to be processed is not currently in the printing device, there is a possibility that a next job will be entered immediately thereafter. The second embodiment also alleviates the load on the cloud by suppressing the sending of Update-Output-Device-Attributes in such cases.

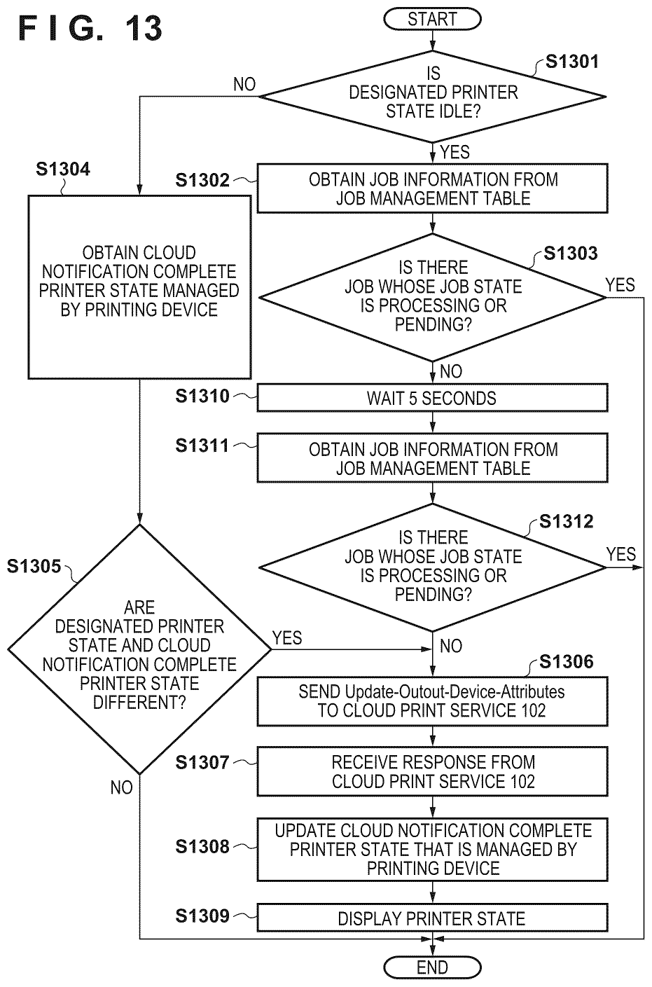

FIG. 13 is a flowchart of when the printing device of the second embodiment sends the device state notification. This flowchart is processing executed in place of FIG. 10, according to the second embodiment, and is substantially the same processing as that in the flowchart in FIG. 10. S1301 to S1309 are the same steps as S1001 to S1009 in FIG. 10. Only the parts related to S1310, S1311, and S1312, which are the differences, will be described.

In S1303, the cloud print device information management unit 405 determines whether a job in which the job-state is “processing” or “pending” is present, based on the obtained job information. If such a job is present, the printer state changes to “processing” immediately thereafter, and the sequence thereof ends without the notification of Update-Output-Device-Attributes being made. If such a job is not present, the sequence moves to S1310.

In S1310, the cloud print device information management unit 405 pauses the processing for a predetermined length of time, which is five seconds in this example. In other words, the execution of S1311 is started five seconds after the execution of S1310 was started.

In S1311, the cloud print device information management unit 405 obtains the job information again from the IPP job management table.

In S1312, the cloud print device information management unit 405 determines whether a job in which the job-state is “processing” or “pending” is present, based on the obtained job information. If such a job is present, the printer state changes to “processing” immediately thereafter, and the sequence thereof ends without the notification of Update-Output-Device-Attributes being made. If such a job is not present, the sequence moves to S1306.

As described above, according to the present embodiment, even if there is no job being processed or standing by to be processed immediately after the printer state transitions to an idle state, the cloud print service 102 is not immediately notified of the printer state. In such a case, whether a job being processed or standing by to be processed is present is determined again after standing by for a predetermined length of time, and if a job being processed or standing by to be processed is present, the cloud print service 102 is notified of the printer state. Accordingly, a plurality of print jobs that are executed at a time interval that does not exceed the predetermined length of time, which is a standby time, can be regarded as the consecutive print jobs described in the first embodiment. The same effects as those of the first embodiment are achieved with respect to the consecutive print jobs. For example, when the user obtains and executes print jobs one by one from the cloud print service 102, the user operations take a longer time than the time required to execute the print jobs, and the jobs may therefore not be consecutive. Even in such a case, the sending of the device state notification can be suppressed, as long as the interval is within the predetermined length of time. Also, providing a step of standing by for the predetermined length of time ensures that the interval between device state notifications for changes in the state of the printer associated with executing jobs is at least the predetermined length of time, which makes it possible to reduce the frequency of device state notifications. This makes it possible to reduce the load on the cloud print service 102. Note that S1302 to S1303 in FIG. 13 may be eliminated, and the sequence may branch to S1310 when it is determined in S1301 that the printer state is the idle state. Doing so makes it possible to perform the determination of whether consecutive jobs are present, which in the first embodiment was performed immediately after the device state becomes the idle state, in the predetermined length of time. Accordingly, the device state notification associated with the progress of the job (e.g., the idle state and the processing state) is not sent for the predetermined length of time following the printer state becoming the idle state. To put this conversely, even if a device state notification is to be sent, that sending is performed after the predetermined length of time. This makes it possible to reduce the frequency of the notifications, and reduce the load on the cloud print service 102. Note that the predetermined length of time to stand by for in S1310 may be determined on the basis of a determination criteria for determining that the cloud print service 102 is under a high load. For example, the standby time may be set to 2×(600/200)=six seconds (or more) when the upper limit exceeded state is returned as a response upon receiving 200 or more device state notifications in a ten-minute period. By doing so, a situation where the upper limit exceeded response is returned can be suppressed even if, for example, a device state notification indicating the idle state is sent every six seconds, and a device state notification indicating “processing” due to a new job being executed immediately following the stated notification is sent.

### Third Embodiment

A third embodiment will be described next. In the first embodiment and the second embodiment, an error is prevented from occurring in advance by reducing the number of times Update-Output-Device-Attributes is sent. However, even with these configurations, it is not possible to reliably prevent errors from occurring, depending on the standby time settings, the timing at which the jobs are sent, and the like. Accordingly, in a third embodiment, the number of times Update-Output-Device-Attributes is sent is managed to reliably avoid situations where errors occur. Note that the present embodiment assumes that an upper limit on the number of times Update-Output-Device-Attributes is sent is set for each printing device registered in the cloud print service 102. If the upper limit is exceeded, an upper limit exceeded response is returned to the printing device 101. The printing device 101 according to the present embodiment also stores a history of device states sent to the cloud print service 102.

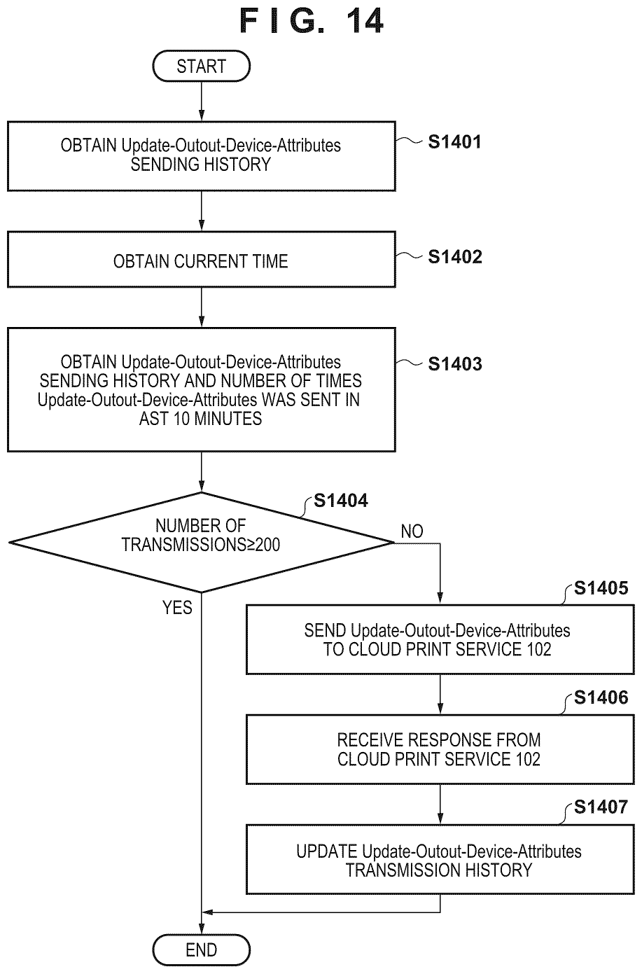

FIG. 14 is a diagram illustrating a flowchart of when the printing device of the third embodiment sends the device state notification. This flowchart is executed when the cloud print device information management unit 405 detects a change in the printer state. It is assumed here that in the cloud print service 102, the upper limit on the number of times Update-Output-Device-Attributes, i.e., the device state notification, is sent, is 200 times in a ten-minute period. Upon receiving device state notifications at a frequency exceeding this upper limit, the cloud print service 102 returns a state code 429 indicating “too many requests” (upper limit exceeded) to the source of the device state notifications. The processing in FIG. 14 is executed instead of the processing of FIG. 10 in the first embodiment.

In S1401, the cloud print device information management unit 405 reads out an Update-Output-Device-Attributes sending history from the storage unit 406. The Update-Output-Device-Attributes sending history is managed by associating sending times with the sent printer-state information.

In S1402, the cloud print device information management unit 405 obtains the current time.

In S1403, the cloud print device information management unit 405 calculates, for example, the number of times Update-Output-Device-Attributes was sent within the last ten minutes. This can be obtained by referring to the Update-Output-Device-Attributes sending history and the current time.

In S1404, if the number of times Update-Output-Device-Attributes was sent exceeds the predetermined upper limit, e.g., is determined to be at least 200, the sequence ends. If not, the sequence moves to S1405.

If the number of times Update-Output-Device-Attributes was sent does not exceed the predetermined upper limit, e.g., is less than 200, in S1405, the cloud print device information management unit 405 sends an Update-Output-Device-Attributes request to the cloud print service 102.

In S1406, the cloud print device information management unit 405 receives an Update-Output-Device-Attributes response from the cloud print service 102.

In S1407, the cloud print device information management unit 405 reads out an Update-Output-Device-Attributes sending history from the storage unit 406. Then, in S1406, the sending time at which Update-Output-Device-Attributes were sent and the sent printer-state information are added and saved in the storage unit 406.

Through the sequence described above, the frequency at which the device state notifications are sent can be suppressed to a frequency lower than the frequency at which the load on the cloud print service 102 is determined to have exceeded the upper limit. As a result, the printing device 101 is prevented from receiving a response indicating that the upper limit of the cloud print service 102 has been exceeded in response to device state notifications.

According to the present invention, smooth usage of a cloud print service can be realized by suppressing error reports to which a user need not respond, while ensuring the state of a printing device can be understood in the cloud print service.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The invention claimed is:

1. A printing device that executes printing on the basis of print data obtained from a server that receives a notification of a state of the printing device and returns a response indicating a predetermined upper limit is exceeded when the notification of the state of the printing device is made at a frequency exceeding the upper limit, the printing device comprising:
at least one memory storing instructions; and
at least one processor that is in communication with the at least one memory and that, when executing the instructions, cooperates with the at least one memory to execute processing, the processing including
sending, to the server, the notification of the state of the printing device in accordance with progress of the printing;
receiving, from the server, a response to the notification of the state sent; and
determining, when a print job is completed and the printing device has entered an idle state, whether a print job to be processed consecutively is present, and if the print job to be processed consecutively is present, controlling the sending to not send the notification of the state of the printing device.

2. The printing device according to claim 1, wherein the processing includes
storing the state of the printing device sent to the server by the sending in a storage,
wherein even when the state of the printing device to be sent to the server matches the state of the printing device stored in the storage, the controlling controls the sending to not send the notification of the state of the printing device.

3. The printing device according to claim 1, further comprising:
a job management table that stores a state of a print job,
wherein the controlling refers to the job management table when the print job is completed and the printing device enters the idle state, and if a print job in a state of being processed or standing by for processing is present, determines that the print job to be processed consecutively is present.

4. The printing device according to claim 1, wherein
when a print job is completed and the printing device has entered an idle state, the controlling immediately determines whether a print job to be processed consecutively is present, and if the print job to be processed consecutively is present, controls the sending to not send the notification of the state of the printing device.

5. The printing device according to claim 1, wherein
when a print job is completed and the printing device has entered an idle state, if the print job to be processed consecutively is determined not to be present, the controlling determines whether the print job to be processed consecutively is present in a predetermined length of time, and if the print job to be processed consecutively is present, controls the sending to not send the notification of the state of the printing device.

6. The printing device according to claim 1, wherein
when a print job is completed and the printing device has entered an idle state, the controlling determines whether a print job to be processed consecutively is present in a predetermined length of time, and if the print job to be processed consecutively is present, controls the sending to not send the notification of the state of the printing device.

7. The printing device according to claim 1, wherein the processing comprises
saving a history in which the state of the printing device sent to the server is associated with a time at which the state was sent,
wherein when the state of the printing device changes, the controlling obtains a frequency at which the state of the printing device has been sent in a most recent predetermined length of time by referring to the history, and if the frequency exceeds a predetermined upper limit, controls the sending to not send the notification of the state of the printing device.

8. The printing device according to claim 7, wherein the processing comprises
displaying information based on the state of the printing device sent to the server.

9. The printing device according to claim 8, wherein information based on a response received from the server is further displayed by the displaying.

10. A non-transitory computer-readable storage medium in which at least one program is stored and, when the at least one program is loaded and executed by a computer, the program causing the computer to execute processing, the processing including
sending, to the server, the notification of the state of the printing device in accordance with progress of the printing;
receiving, from the server, a response to the notification of the state sent; and
determining, when a print job is completed and the printing device has entered an idle state, whether a print job to be processed consecutively is present, and if the print job to be processed consecutively is present, controlling the sending to not send the notification of the state of the printing device.

11. A control method for a printing device that executes printing on the basis of print data obtained from a server that receives a notification of a state of the printing device and returns a response indicating a predetermined upper limit is exceeded when the notification of the state of the printing device is made at a frequency exceeding the upper limit, the method comprising:
sending, to the server, the notification of the state of the printing device in accordance with progress of the printing;
receiving, from the server, a response to the notification of the state sent; and
determining, when a print job is completed and the printing device has entered an idle state, whether a print job to be processed consecutively is present, and if the print job to be processed consecutively is present, controlling the sending to not send the notification of the state of the printing device.
